(19) United States
(12) Patent Application Publication
(10) Pub. No.: US 2006/0198317 A1
(43) Pub. Date: Sep. 7, 2006

(54) METHOD FOR CONTROLLING A SERVICE TO USE A RESOURCE

(76) Inventor: Cheng-Yin Shen, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/164,888

(22) Filed: Dec. 8, 2005

(30) Foreign Application Priority Data
Dec. 17, 2004 (TW) 093139366

(51) Int. Cl. H04J 3/14; H04L 12/26; H04J 1/16

(52) U.S. Cl. 370/252

(57) ABSTRACT

A method for controlling a service to use a resource is disclosed. The method includes the steps of: starting the service; obtaining a license of using the resource; determining whether a report of running the service is received at regular intervals; and withdrawing the license if no such report is received. By using the invention, status reports of running the service are received at regular intervals, and the license of using the resource can be withdrew if such reports are not received at regular intervals to avoid the resources being occupied enduringly.

### FIELD OF THE INVENTION

The present invention relates to a method for controlling a service to use a resource in a computer system.

### DESCRIPTION OF RELATED ART

In computer systems, there are many resources, such as CPUs, memories, hard disks, CD/DVD ROMs, tape devices and so on. Each computer system provides large numbers of services for users. During the period of running the services, corresponding resources need to be used. Before a service begins to use a resource, the computer system always needs to generate a request of using the resource by the service, and then, the corresponding resource releases a license to the service. After the service obtains the license, the service can use the resource.

However, something unpredictable may occur after the service gets the license. For example, when an error occurs, the license of using the resource by the service cannot be withdrew by using conventional technologies, and the resource would be occupied by the service enduringly when the computer system is working.

Therefore, what is needed is a method for controlling a service to use a resource in a computer system, in which status reports of running the service are received at regular intervals, and the license of using the resource can be withdrew if such reports are not received at regular intervals.

### SUMMARY OF INVENTION

A method for controlling a service to use a resource is provided. The method includes the steps of: starting the service; obtaining a license of using the resource; running the service after the service has obtained the license of the resource; determining whether a report of running the service is received at regular intervals; withdrawing the license if no such report is received.

The step of determining whether a report of running the service is received at regular intervals further includes the step of: returning to the step of keeping on running if such a report is received at regular intervals.

The step of obtaining a license of using the resource further includes the steps of: obtaining an active bitmap of the resource, the active bitmap recording at least one service which is using the resource; deleting from the active bitmap services whose reports of using the resource are not received at regular intervals; obtaining a blacklist bitmap of the service, the blacklist bitmap recording at least one service which cannot share the resource when the service is using the resource; determining whether there is any service in the blacklist bitmap which is also in the active bitmap; adding the service to the active bitmap if there is not such service exists; releasing the active bitmap and blacklist bitmap; and returning a truth message.

The step of determining whether there is any service in the blacklist bitmap which is also in the active bitmap further includes the step of: returning a false message if there is such a service exists.

Other advantages and novel features of the embodiments will be drawn from the following detailed description with reference to the attached drawings, in which:

### BRIEF DESCRIPTION OF DRAWINGS

FIG. 1 is a schematic diagram of an application environment for implementing a preferred method for controlling a service to use a resource;

FIG. 2 is a flowchart of a preferred method for controlling a service to use a resource; and

FIG. 3 is a flowchart of obtaining a license of using a resource.

### DETAILED DESCRIPTION

In order to describe the preferred embodiment of the invention conveniently, the following are definitions of important technical terms used in the preferred embodiment: (1) Active bitmap: a bitmap which belongs to a resource and records at least one service using the resource currently. For example, a memory is viewed as a resource in a computer system, which can be used by various services, such as A, B, C and D. Supposing that the memory are being used by the services A, B and C, the active bitmap of the memory records the services A, B and C; (2) Blacklist bitmap: a bitmap which belongs to a service and records at least one service which cannot share a resource with the service at the same time. For example, a service E denotes reading data from a hard disk, and a service F denotes formatting the hard disk. Obviously, the service E and the service F cannot work at the same time on the hard disk. Therefore, the blacklist bitmap of the service E records the service F.

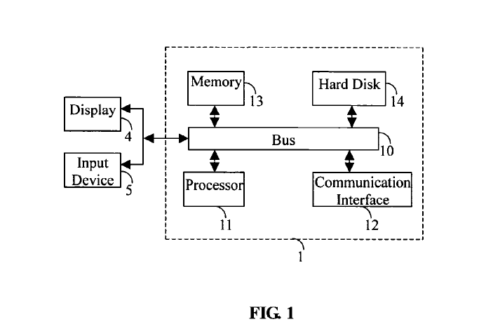

FIG. 1 is a schematic diagram of an application environment for implementing a preferred method for controlling a service to use a resource. The application environment includes a computer system 1, a display 4 and an input device 5 which connect with the computer system 1. The computer system 1 typically includes a bus 10, a processor 11 for processing information and instructions transmitted by the bus 10, a communication interface 12 providing a bidirectional communication mode for transmitting and receiving data, a memory 13 and a hard disk 14. The memory 13 is for storing the information and instructions processed by the processor 11. The memory 13 may include a ROM (read-only memory), a RAM (random access memory) and a cache memory. The hard disk 14 is used for storing a plurality of system software and application software (e.g. a controlling program which controls a service to use a resource). All the components mentioned above in the computer system 1 can be viewed as resources. When a user sends an instruction of controlling a service to use a resource through the input device 5, the instruction is stored in the memory 13 after the instruction is transmitted by the bus 10. Then, the processor 11 generates a request to the resource according to the instruction stored in the memory 13, and the service starts.

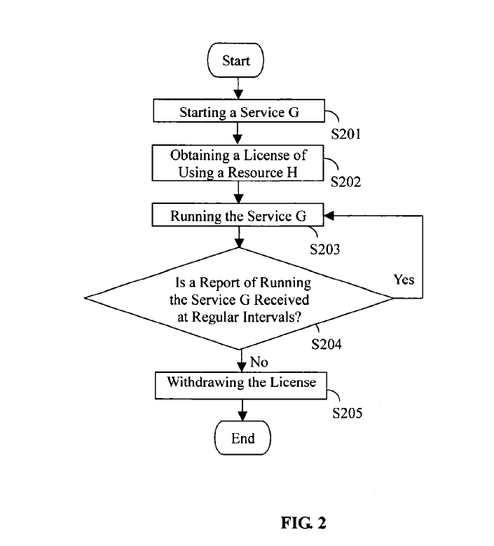

FIG. 2 is a flowchart of a preferred method for controlling a service to use a resource. In step S201, when a user sends an instruction of controlling a service G to use a resource H by using the input device 5, the processor 11 generates a request of using the resource H. Then, the service G starts. In step S202, the service G obtains a license of using the resource H. If the service G does not obtain the license of using the resource H, the processor 11 returns a warning message. In step S203, the service G keeps on running after the service G obtains the license of using the resource H. In step S204, the processor 11 determines whether a report of running the service G is received at regular intervals. The regular intervals can be set according to demands of the user. If no such report is received, in step S205, the processor 11 withdraws the license of using the resource H, and ends the service G. Otherwise, if a report of running the service G is received at regular intervals, the procedure returns to step S203 describe above.

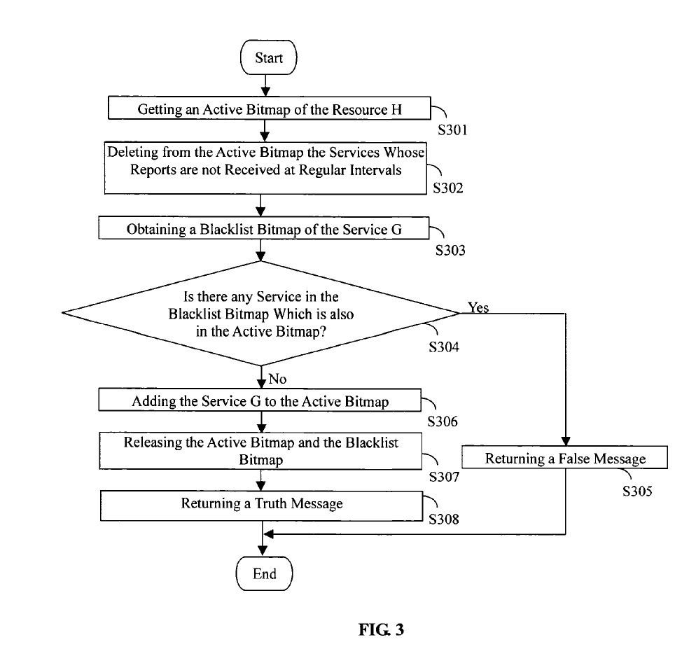

FIG. 3 is a flowchart of a preferred method for obtaining the license of using the resource H. In step S301, the processor 11 obtains an active bitmap of the resource H. The active bitmap records at least one service which is using the resource H. In step S302, the processor 11 deletes from the active bitmap the services whose reports of using the resource H are not received at regular intervals. In step S303, the processor 11 obtains a blacklist bitmap of the service G. The blacklist bitmap records at least one service which cannot share the resource H with the service G when the service G is using the resource H. In step S304, the processor 11 determines whether there is any service in the blacklist bitmap of the service G which is also in the active bitmap of the resource H. If such a service exists, in step S305, the processor 11 returns a false message which means the service G cannot obtains the license of using the resource H. Otherwise, if no such service exists, in step S306, the processor 11 adds the service G to the active bitmap of the resource H. In step S307, the processor 11 releases the active bitmap of the resource H and the blacklist bitmap of the service G. Then, in step S308, the processor 11 returns a truth message, which means the service G successfully obtains the license of using the resource H.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A method for controlling a service to use a resource in a computer system, the method comprising the steps of:
starting the service;
obtaining a license of using the resource;
keeping on running the service;
determining whether a report of running the service is received at regular intervals; and withdrawing the license if such a report of running the service is not received at regular intervals.

2. The method according to claim 1, wherein the step of determining whether a report of running the service is received at regular intervals further comprises the step of:
returning to the step of keeping on running the service if such a report is received at regular intervals.

3. The method according to claim 1, wherein the step of obtaining a license of using the resource comprises the steps of:
obtaining an active bitmap of the resource;
deleting from the active bitmap the services whose reports of using the resource are not received at regular intervals;
obtaining a blacklist bitmap of the service;
determining whether there is any service in the blacklist bitmap which is also in the active bitmap;
adding the service to the active bitmap if no such service exists;
releasing the active bitmap and the blacklist bitmap; and
returning a truth message.

4. The method according to claim 3, wherein the step of determining whether there is any service in the blacklist bitmap which is also in the active bitmap further comprises the step of: returning a false message if such a service exists.

5. The method according to claim 3, wherein the active bitmap records at least one service which is using the resource currently.

6. The method according to claim 3, wherein the blacklist bitmap records at least one service which cannot share the resource with the service when the service is using the resource.
